(19) United States
(12) Patent Application Publication
(10) Pub. No.: US 2005/0213511 A1
(43) Pub. Date: Sep. 29, 2005

(54) System and method to track wireless device and communications usage

(75) Inventors: Richard William Reece JR., Lee, NH (US); Matthew J. Stowell, Saco, ME (US)

Correspondence Address: Richard W. Reece, 4 Captain Parker Drive, Lee, NH, 03824, US

(73) Assignee: MERLIN MOBILE MEDIA, Lee, NH (US)

(21) Appl. No.: 10/907,229

(22) Filed: Mar. 24, 2005

Related U.S. Application Data
(60) Provisional application No. 60/557,362, filed on Mar. 29, 2004.

(51) Int. Cl. H04Q 7/24

(52) U.S. Cl. 370/252; 370/338

(57) ABSTRACT

A system and method for gathering and reporting user and device activity data from wireless communication devices through a log file. The log file stores entries related to user events including the use of communications and applications, as well as access to local and remote media resource files. The log file entries may include parameters critical to mobile device operation such as location, signal quality, and battery power. The data gathering system comprises a plurality of wireless communications devices, each of which sends the log files through an available wireless communications system to a central facility for processing and aggregation into a database. Stored data is analyzed to generate, display, and marketing information that may include historical trends and projections of future consumer preferences and activities.

### FIELD OF THE INVENTION

This invention relates to a system and method for collecting, recording, reporting, and analyzing data concerning pre-defined operations on one or more mobile cellular communications devices.

More specifically, the present invention relates to mobile cellular communications devices known in the current art as “smart phones” or “advanced mobile devices”. These phones and devices include the processing chip sets, operating system software, protocol stacks, and user interface necessary to provide: one, mobile communications in a cellular network; two, the capability to operate third-party software applications installed by a consumer of no particular skill in the art.

### DESCRIPTION OF THE RELATED TECHNOLOGY

Mobile phones have a very high market penetration rate that continues to grow at a rapid pace on a global scale. The technical capabilities of mobile communications devices are also increasing and now include more substantial computing resources. “Smart phones” and mobile-enabled PDAs provide both mobile communications and basic computing services, including the capability to download and operate third-party applications after the phone has been manufactured, distributed, and sold.

Consumers, companies, governments, and organizations all have a need to measure, analyze, and report how consumers operate their mobile phones. This demand includes a need to obtain information on how consumers use the expanding communications functions (e.g. voice, packet data, circuit switched data, messaging) and the new applications now appearing in an increasing number of phones (e.g. games, calendars, word processing).

For mobile market research, it is important to collect information about the user's activities and the context of those activities. In the field of mobile communications, there is no system and method that provides context and activity data drawn from actual consumer usage, at the point of use, in a unified, consistent manner that is independent from a network operator, device manufacturer, or other participant in the mobile value chain.

In the current art of mobile cellular communications, a limited range of mobile consumer activity and context data is collected by mobile network operators for a variety of purposes including network design and testing, service provision, and billing. For the purposes of this disclosure, these data collection systems and methods may be split into two general categories: network-based and device-based.

Network-based systems are of limited utility for market research purposes. One, mobile network operators own this data and rarely make it available to third parties. Two, these systems are designed for purposes other than market research so the location, structure, and functions of these systems will not be optimized for market research uses. Data indicating consumer activity and context data is often located in several databases, which may or may not be part of the same system, and may or may not be readily and economically accessible. Three, data collection methodologies vary from operator to operator. Fourth, network-based systems capture network activity, not device-side activity. This last limitation is significant, particularly as phones become “smarter” and operate as multi-purpose communications and entertainment devices. Network-based data indicates a device's interaction with the network, but reveals nothing about user activity with the device when no connection to the network is required or available.

Device (or mobile phone-based) data collection systems and methods are known in the prior art but also have significant limitations. There are two general categories: service and communications testing, and device-based billing systems.

Device-based systems that test or evaluate the performance of the mobile communications network from are known in the prior art. Some of these systems use highly sensitive, specialized radio systems designed to collect a wide range of data parameters. Others include an “engineering” or “field test” software application on mobile cellular devices that may be activated using specialized codes or equipment. This specialized software collects and reports engineering-related communications data, usually through the screen interface or a serial port.

Device-based systems designed for the purpose of radio-engineering testing and evaluation offer limited, if any, benefit to market researchers in the field of mobile communications. One, these systems collect radio engineering related data but do not provide data on a real subscriber's actual communications and applications usage patterns. The radio engineering systems do not collect information about non-communication application use, such as when an organizer application is opened or a game is played. Two, these systems are either executed as special-purpose stand-alone devices or pre-installed as software by the device manufacturer. Both methods require special activation and data translation by qualified individuals with special knowledge in the art. Third, these systems are not designed for long-term usage pattern study where the data collection system must operate autonomously without user supervision or intervention. Fourth, these prior art systems are not capable of widespread deployment in devices operated by actual consumers of no particular skill in the art of mobile communications engineering.

Device-based billing systems are also well known in the current art. For the purposes of market research, a device-based billing system may collect usage data at the point of use, in the device, but in an actual market research program such systems are of limited use. Many of the same limitations noted for network-based billing systems also afflict device-based billing systems: the data is owned by network operators, formatted for billing purposes, variable between network operators, and does not capture non-communications device usage.

In summary, the prior art in the field of mobile communications systems provides a range of systems and methods for collecting data regarding mobile communications use, but these systems either are completely unusable as market research systems or have inherent drawbacks that sharply restrict the quality of the research that may be executed.

In the field of monitoring personal computing and network usage, prior art systems aim to collect, log, and analyze operations conducted by users on personal computers. However, systems from this field of art will suffer severe limitations and operating problems when applied to mobile smart phones or cellular communications-enabled PDAs.

Those skilled in the art of mobile communications devices will recognize that the requirements and constraints of the mobile device's physical environment results in systems and methods that are quite different from those designed for stationary personal computers. In comparison with a personal computer (or laptop), a mobile smart phone or cellular communications-enabled PDA must be very small, power efficient, and capable of executing communications while mobile by using a cellular network. It must use a much smaller user interface, with limited user-input capabilities. A personal computer, even a laptop, is several times larger than a smart phone, has considerably larger batteries, and is not designed for extensive wireless communications without a power cord. This environment allows for a more substantial user interface, and a wider range of user input options, including keyboards.

The substantial physical constraints faced by mobile communications devices results in substantial differences in hardware and software. For example, the processors used in a mobile communication system must be smaller and more power-efficient than the chip sets used for stationary or laptop computers. Operating systems for mobile communications are substantially and often fundamentally different from PC-based operating systems. For example, the operating system must be capable of smoothly and quickly pre-empting running applications when a voice call is received.

Just as the processors and operating systems upon which these applications run are completely unsuitable for the mobile environment, so too is the prior art for collecting usage data on personal computers unsuitable for mobile phones.

For example, the prior art of personal computing data collection systems lacks the systems and methods necessary for tracking mobile communications data. This prior cannot collect critical mobile communications usage data such as the remote party number (caller identification), the signal strength at the time of the call, or the time and direction of a mobile message.

In addition, these systems lack the capability to determine the user's location. Location data is particularly critical for any market research in mobile systems because, by definition, the user moves and the context of the activity changes. These are obvious and substantial limitations to applying prior art from personal computing to mobile devices, even those with increased computing resources.

Other limitations exist. Because of the stationary, power-rich environment, prior art computing systems have no need to conserve processor clock cycles, memory, or bandwidth. So these systems are able to utilize processor or memory intensive solutions that are designed to intercept and filter (or record) a large percentage of the operating system's internal messages. In a mobile implementation, these systems would consume such a high percentage of the mobile device's resources—processor cycles, memory, and battery—that the data collection process would be extremely brief and ineffective. In addition, high memory and bandwidth use would impose higher economic costs, a critical factor that would in turn limit the overall sample size and effectiveness of a market research system.

Furthermore, there is a great deal of variability in the capability and functions of mobile devices, even in devices using the same operating system. This, combined with an average handset turnover rate of 18 months in most countries, requires a flexible market research system capable of rapid adaptation to new devices, operating system variants, new functions, and rapid device turnover. Neither the prior art for engineering testing and billing in the mobile communications field, nor the prior art in the personal computer monitoring field is structured to collect point of use mobile data using processes or structures designed to match this dynamic environment.

In summary, the prior art in several different fields of art is inadequate to the task of delivering a system and method in the field of advanced mobile cellular communications that is capable of collecting, delivering, and analyzing extensive communications, applications, and device usage data drawn from the point of use, in consumer devices, at a cost that is economical enough to support a large sample of consumers.

### SUMMARY OF THE PRESENT INVENTION

The present invention provides a system and method that collects mobile cellular device usage data at the point of use, in consumer devices, then delivers this data through a wireless Internet connection to a central server and database for analysis. In a preferred embodiment, the portion of the data collection process operating in mobile devices executes as a software application installed by a consumer of no particular skill in the art after the device's manufacture, sale, and distribution. Furthermore, this software operates in the background automatically, without user intervention, to collect a wide range of data on a consumer's activities and the context of those activities in using methods that minimize processor usage, battery consumption, and memory and bandwidth overhead. In the preferred embodiment, the data collected includes all communications and application use as well as data indicating a consumer's location and the status of device parameters. The time-stamped logs generated by this process are automatically compressed, encrypted, and uploaded through the Internet to a central server and database for storage and analysis.

This system and method provide considerable advantages over the prior art.

One such advantage of the present invention is that the device-based software may be installed by a consumer with no particular skill in mobile communications or computing through a variety of convenient mechanisms to the mobile device. This capability enables the assembly of large samples of actual mobile consumers in a short period of time and low cost.

A related advantage is that the data collection process of the present invention may be executed by an independent third party unaffiliated with a network operator or a device manufacturer. This independence insures broader access to the data, lower costs, and more consistent measurement methods across networks and devices.

Another advantage is that the present invention's data collection system efficiently gathers and aggregates a wide range of data parameters using a single system. The data collected by the system of the present invention may be used to replace the multiple unrelated methods that would be required to draw similar, though incomplete data, from a range of technical fields in the prior art. The present invention collects data relevant to radio engineering, device design, communications service, application design and use, and general market research in a unified system. As an added advantage, the system and methods of the present invention collect this data from actual consumers using the device as their normal mobile cellular phone.

This integration of multiple systems generates further advantages. For example, the present invention measures and collects the cell identification, a GPS location, and signal quality level during actual calls made by actual subscribers. This unified set of data provides a means of identifying and prioritizing radio dead spots in a cell by potential (and lost) communication value as well as radio signal levels. In addition, it is able to determine places where consumers may not be making calls because of poor coverage. This specific use alone directly increases the productivity of network engineers as they are able to focus limited resources on building-out capacity in areas with the demonstrated capability to generate higher revenue.

Yet another advantage is the system and methods of the present invention minimize processor, battery, memory, and bandwidth use, a particular advantage in mobile communications. In turn, these benefits generate further economic advantages by reducing the overall cost and burden of collecting and reporting actual usage data from the point of use. At the same time, the present invention also provides a flexible structure so that a market research program may be updated rapidly in response to market conditions and evolving device capabilities.

In addition, the system and method of the present invention also provide the capability to deliver the data logs through the Internet to a central server and database in near-real time. This provides instant feedback for market researchers, eliminating the delays involved with much of the prior art.

A further objective and advantage of the present invention is to monitor, collect, and report location data before, during, and after specific device and user-related events.

Advantageously, the system and method provides a means for utilizing a private key encryption system. Some implementations may not require encryption. However, in a mobile environment, the private key encryption method of the present invention provides considerable advantages over non-encryption, public key encryption, or a hybrid of public and private key systems such as the Secure Socket Layer (SSL). One advantage of the preferred encryption method is that it provides greater security using fewer processing cycles than public key systems. A second advantage is that no bandwidth or processing overhead is required to agree on a key scheme or conduct a key exchange (as in SSL). A third advantage is that the private key system also reduces the processing load on the server, reducing the overall cost of using the system of the present invention when compared with alternative options.

In addition, in a preferred embodiment the present invention collects a time stamp provided by the cellular network. This “network time” enables the data from multiple users to be calibrated to a common reference time. Advantageously, researchers may review usage data in terms of the individual times (as understood by the users) and from the perspective of the common reference time so that the data from a large sample of users may be usefully aggregated.

### BRIEF DESCRIPTION OF THE DRAWINGS

FIG. 1 provides general overview of the major components and data flows of the present invention

FIG. 1A provides a more detailed diagram summarizing the overall process flow of the present invention.

FIG. 2 provides a flow diagram related to the process of installing the logging software in user devices.

FIG. 3 provides a flow diagram summarizing the preferred activation process.

FIG. 4 provides a flow diagram indicating the general process for event-driven data collection in a preferred embodiment of the present invention.

FIG. 5 provides a block diagram of the primary objects in a preferred embodiment of the present invention.

### DETAILED DESCRIPTION OF THE PRESENT INVENTION

System and Method Overview

According to the present invention, a system is provided to monitor, collect, store, and transport information concerning the use of a mobile cellular communications device.

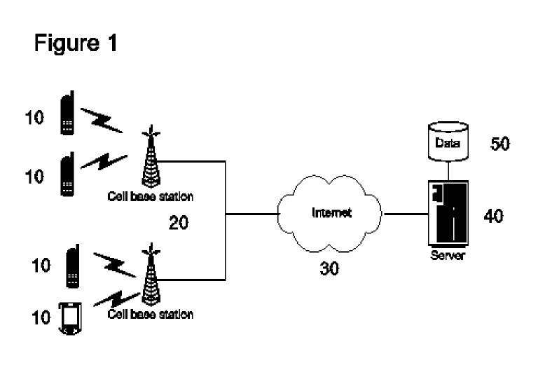

FIG. 1 provides a general overview of the major components and data flows of the present invention. A number of consumers operate mobile cellular communications devices with an independent operating system (such as Symbian or Palm) or facility to operate third-party applications (such as Java) (10). Data collected is uploaded via a cellular wireless connection (20) and routed through to the Internet (30) to a centralized server (40) and database node (50).

FIG. 1A provides a more detailed diagram summarizing the overall process flow of the present invention. A user monitoring, recording, and reporting system (“logging software”) operates in one or more mobile cellular communications devices (“mobile devices”). A user of no particular skill operates the mobile device in a normal, ordinary manner (110). In this disclosure, this operation is also advantageously described as a set of “activities” the consumer executes using the device. Such activities include using the communications and applications services as well as moving from place to place with the device.

The logging software captures information regarding a user's activity and the context of the activity (120). This information is stored as a chronological log in local memory on the device (130). Those skilled in the art will recognize that a variety of techniques are available to enter activity event and contextual parameter data into a chronological log. Where possible, the logging operation aggregates data related to a single event under the same time stamp in order to minimize the overall size of the logs in memory and transport.

An event trigger initiates an upload of the logs through the cellular network (140). Those skilled in the art will recognize that several events may be used. In the preferred embodiment, the logs will upload periodically using an event notification controlled by a timer. The periodic upload is advantageous for researchers, who must receive data on a regular basis from all participants in the research panel in order to insure the proper data sample size and valid comparisons. Alternatively, an upload may initiate when a log file reaches a pre-determined size, or after a specific activity.

In the preferred embodiment, the logs are compressed (142) and encrypted (144) before the upload is executed.

Logs upload using a wireless data connection to the Internet and a central database and server (150). Preferably, the logging software automatically executes a connection to the Internet through a cellular packet data connection. Alternatively, a local wireless service such as a WiFi or Bluetooth node may provide the connection to the Internet, if the device and the node support the Internet connection process. In general, the cellular data network provides greater advantages because its greater range and availability helps insure timely data uploads. Alternatively, if a wireless packet data system with a connection to the Internet is unavailable, the system automatically executes a wireless dial-up data call to an Internet Service Provider (ISP) or a modem directly connected to the server and database (152).

The server receives the upload and validates the identity of the user (160). As required in the preferred embodiment, the server decrypts (162) and decompresses (164) the logs. The server (or the database) extracts, parses, and prepares the data from the logs for storage in the database (170). The data is then stored in a series of tables in a standard database (180). This data is retrieved, aggregated, and queried to form tables and reports for clients of a market research program (190). The data, queries, and reports are provided either in hard copy format, stored and sent in a standard file, or accessed through a Web interface.

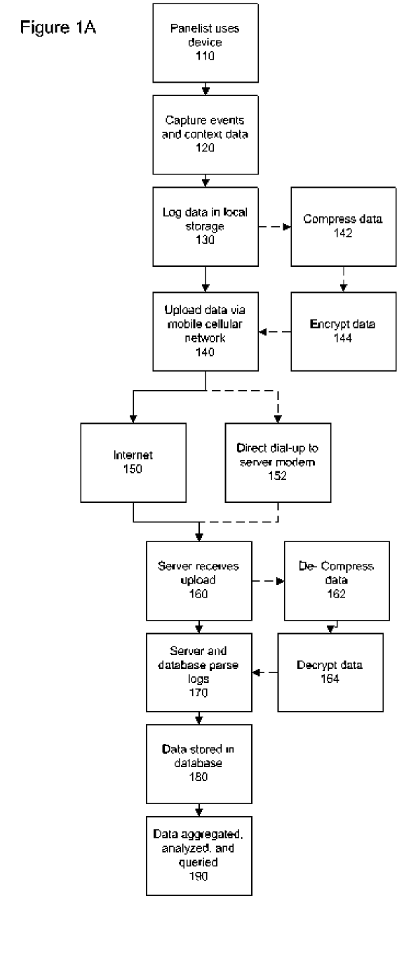

FIG. 2 provides a flow diagram related to the process of installing the logging software in user devices in a preferred embodiment of the present invention. In such an embodiment, the logging software is installed by a user of no particular skill in communications or computing through an over-the-air download.

The panelist (“user”) is identified through standard means known to those with experience in market research programs (210). Selecting users from an existing population of mobile subscribers is preferable. Once the users are identified and equipped with a suitable mobile device (220), the logging software is installed (230), preferably by the user. The preferred method is to install the software via a wireless communication, over-the-air (240). There are several techniques known to those in the art, including a direct WAP or Web download, or as an attachment to a message. Otherwise the user may install the software using a local PC-mobile device link conducted over WiFi, infrared, Bluetooth, serial cable, USB, or any other local connection system (250).

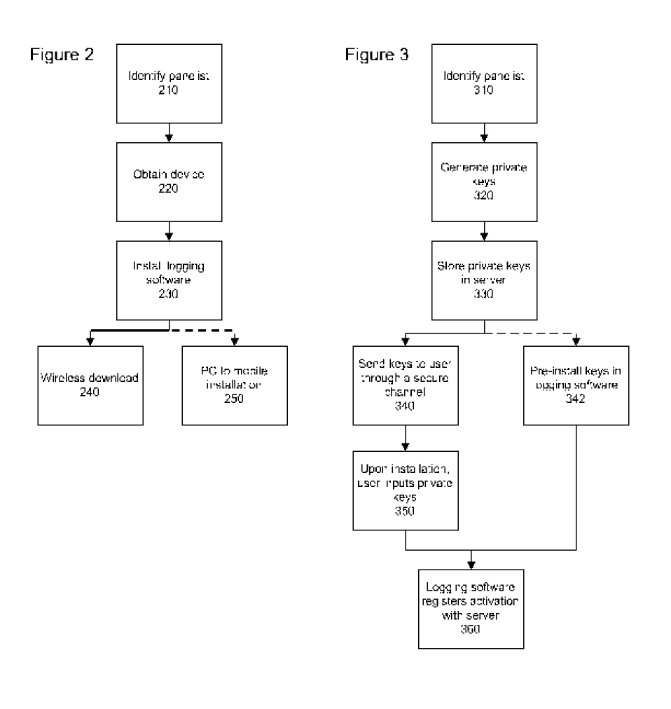

FIG. 3 provides a flow diagram summarizing the preferred activation process. When the panelist agrees to participate in the research program (310), a private encryption key is generated for the specific user (320). These keys are stored in a secure user identification-key database in the server (330), a process known to those skilled in the art. The private key is then communicated to the user, preferably through a secure channel or one with a low probability of interception (340). While the data logs are private, interception and decryption would not, in most instances, present a significant security risk to the user. As a result, any number of channels may be used to deliver the private key including postal mail, email, a phone call, or even an SMS message. After installation, the logging software requests that the user enter this private key through a simple data input interface (350).

Alternatively, if the above steps are too complex or expensive for a particular research program, the private key may be installed directly into the logging software, for every individual user, preferably before compilation (342).

In both key distribution scenarios, after key entry and confirmation the logging software automatically registers with the server (360) via a wireless link to the Internet to “activate” the user's account and confirm participation.

General Operating Characteristics

The following description provides further details regarding the general operating characteristics of the logging software in a preferred embodiment of the present invention.

Auto-Start

In the preferred embodiment, the logging software auto-starts whenever the device is switched on so that no user intervention is required.

User Interface

In a preferred embodiment, once installed and activated, the logging software will provide no user interface or controls. However, in some embodiments, it may be advantageous to provide the user with a minimal screen or menu reference indicating that research software is installed and operating.

Background Operation

In the present invention, the logging software operates completely in the background so that no user intervention is required for operation. This is clearly advantageous for the purposes of data collection and research.

Data Collection

In the present invention, the structure and processes of the mobile device logging software are optimized for the specific demands and requirements of the mobile environment. One critical aspect and advantage of the present invention is the use of a highly targeted, event-driven method of collecting data about user activities and the related context.

A user “activity” is a specific action that utilizes one of the functions of the mobile device. Examples include conducting a mobile phone call, sending a message, or using an application.

Advantageously, activities may be represented as a series of one or more discrete events. For example, an SMS may be represented as a single event: message sent. A voice call is better represented by two events: call start and call termination.

Preferably, each event also results in a state change in the operating system. This state change triggers a message or notification from the operating system. The logging software of the present invention “waits” for an event notification and then collects “context parameters” relevant to the specific event. These parameters place the user's activity in “context”. For example, for a voice communication, contextual parameters may include the date, time, location, signal level, remote party identification, battery level, and charger status.

Many operating systems designed for the mobile environment utilize an event-oriented architecture. Symbian, for example, utilizes “active objects” in a “client-server” architecture. Clients request event notifications from function-specific servers. Active objects receive the event notifications and then perform pre-defined processes. When available, event-driven processes are preferred because they eliminate resource-consuming polling and filtering operations.

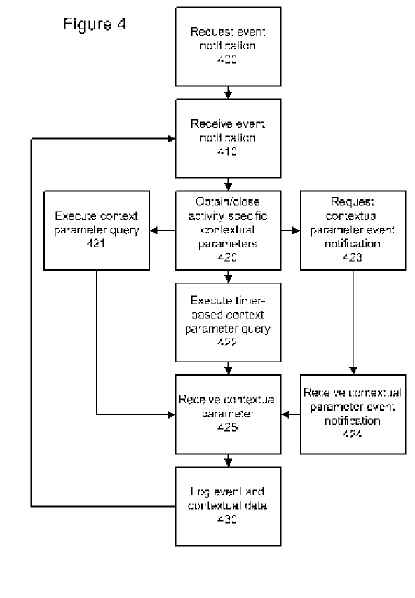

FIG. 4 provides a flow diagram indicating the general process for event-driven data collection in a preferred embodiment. This embodiment executes in a mobile operating system such as Symbian where asynchronous event notifications are supported. Those skilled in the art will recognize that there are alternative operating systems and programming techniques which may be use to implement the system and methods of the present invention.

In the preferred embodiment, the logging software registers with the operating system to receive event notifications that represent a targeted user activity (400). In an alternative embodiment, the logging software may use a serial interface provided by the operating system to register a notification request directly with the communication protocol stack (“communications operating system”) for some communications events.

For most target activities, the normal resting state is “inactive”. So the standard event notification is a “start”, “active”, or “on” event notification (410).

Once the event is received, the logging software collects context parameters relevant to the specific events and user activity (420). The methods used to collect contextual parameters depend on the parameter itself and the granularity required for the research program.

Some contextual data parameters have a static value for the duration of the activity. For example, the dialed telephone number remains the same for the duration of a voice call. Static contextual parameters are obtained using a one time query of the operating system or communications system (421).

Other contextual data parameters are dynamic and so change over the course of the activity. For instance, signal strength is a contextual parameter that varies over the duration of a mobile voice call. There are at least two options for measuring dynamic contextual parameters over the course of an activity. One, a periodic query initiated by a timer may be used (422). Two, the logging software requests that the operating system send an event notification when a targeted parameter reaches a pre-defined threshold or state (423). The logging software maintains a process, thread, or active object to receive the specific event notification (424). The second process is preferred when available and possible.

Once obtained, the logging software processes the value for the context parameter (425). Processing includes preparing the format of the parameter so that it is suitable for entry into the log. In a preferred embodiment, for context parameters where the range of values is known in advance, a coding system is used to replace longer text entries in order to reduce the size of the entry and the overall size of the log.

The event and context parameter values are written to one or more log files and stored in local memory (430). Log entries include a time stamp. Those skilled in the art will observe that the log entry process may occur upon receipt of the event notification, or at any point in the course of the activity.

The operating system sends an event termination notification when the activity ends. An event termination is generally handled by the same process flow as an event start notification, though the specific context parameters retrieved by the logging software may differ. In most cases of activity termination, only one-time queries associated with the action of termination are used. Any outstanding timed queries or event notification requests for context parameters are closed after receiving an activity-specific termination event notice.

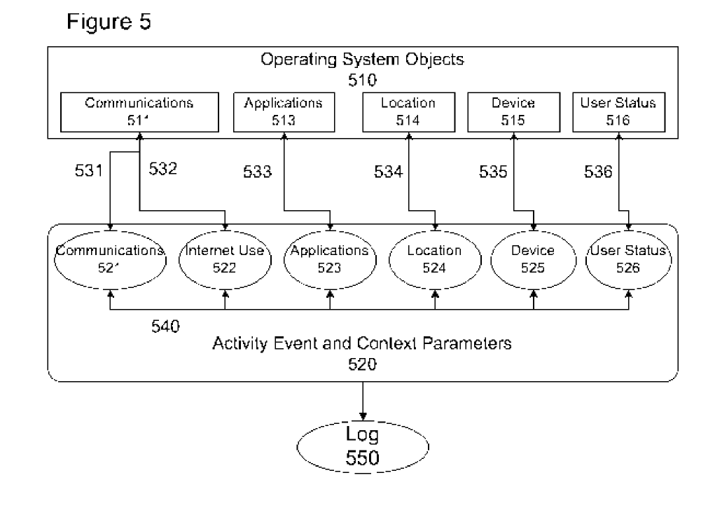

FIG. 5 provides a block diagram of the primary objects in a preferred embodiment of the present invention. In this description, activity-specific processes are grouped into objects that execute the generalized process indicated in FIG. 4.

A modular, object-oriented program structure is preferable as it allows rapid adaptation to changing market research requirements and device capabilities. However, one skilled in the art will appreciate that the system and methods of the present invention may be executed using different objects or programming techniques than those described here.

In FIG. 5, the block representing the operating system contains a set of activity-specific objects (510). In this description, the objects that handle target activities are segmented into five general categories: Communications (511), Applications (513), Location (514), Device (515), and User Status (516).

This block diagram of the operating system provides a simplified reference and grouping of the application programming interfaces offered by the operating system. Some operating systems, such as Symbian, use “servers” that roughly correlate with the operating system objects represented in this block diagram. However, those skilled in the art will recognize that this is descriptive convenience, as operating systems may not group all the relevant processes into objects, servers, or processes that correlate with an activity object of the present invention's logging software. And of course any operating system includes far greater functionality, though such functions are outside the scope of the present invention and are well known in the art.

The processes the logging software uses to collect data from the operating system are collectively represented in FIG. 5 as Activity Event and Context Parameters Module (520). This module (520) serves as a reference to the data collection processes of the logging software, and is not intended to provide a comprehensive view of all processes executed by the logging software.

As in the operating system, these processes are grouped into six “activity objects” including: Communications (521), Internet Use (522), Applications (523), Location (524), Device (525), and User Status (526). Many of these objects are further sub-segmented to target more specific activities. These sub-segments are described in greater detail in the Data Collection section of the description of FIG. 5.

In operation, the messages executing the process flows outlined in FIG. 4 are exchanged between the logging software's objects and the relevant operating system objects. These messages include event notification requests, event notifications, data queries, and other messages required to obtain the target events and data. The specific exchange of messages between these objects is represented by indicators relevant to the target activity: 531 (Communications), 532 (Internet and protocol use), 533 (Applications), 534 (Location), 535(Device), and 536 (User Status).

Within the Activity Event and Context Parameters Module (520), the various logging software Activity objects also exchange messages. These messages include status updates, event notifications, requests for data, and data values for specific parameters (540). An Activity object communicates with other Activity objects primarily to obtain contextual parameters. This inter-object communications allows one Activity object to provide common contextual parameters to other Activity objects. As known in the art, this exchange of messages between objects reduces the overall size and complexity of the program by re-using code.

The Activity objects within Activity Event and Context Parameters Module (520) pass activity event and contextual parameters to the Log object (550). The Log object is responsible for generating a time stamp, formatting the data, and adding the data to the Log file.

Detailed Description of Activity Objects

Communications Activities

In FIG. 5, the collection of communication activity events and context parameters is represented by the messages exchanged (531) between the operating system Communications module (511) and the logging software's Communications object (521).

In the preferred embodiment, communications activities include all cellular network communications executed by mobile device. These capabilities may vary from device to device, but in the preferred embodiment the targeted communications activities include: voice, SMS, MMS, email, and packet data communications.

In a preferred embodiment, the Communications object is further sub-segmented into sub-objects targeting a specific communication type (e.g. voice, packet data, SMS). Depending on the communication type, none, some, or all of the event and context parameter processes are shared between the sub-objects.

In a preferred embodiment, all communications events include “start” and “terminate”. Messaging is the exception as it typically utilizes a single event notification. Preferably, context parameters for all communications types include: call direction (e.g. mobile originated or mobile terminated) remote party identification (e.g. called number, caller identification), location, signal level, battery level, and call exit code. Some context parameters are specific to the communication type. For example, a voice call preferably includes a call duration parameter measured in units of time, while an SMS message includes a counter indicating the number of concatenated messages, and a packet data communication includes parameters indicating bytes sent and bytes received.

As with all Activity objects, the Communications object may request a context parameter from a different object (540). For example, a voice call object requests the signal level from the Activity object “Device”.

Advantageously, in the preferred embodiment, upon communication termination the Communications object collects the communication exit code, if available. The exit code is provided by the network to the mobile device, and codes in the GSM system include “Network out of order”, “temporary failure”, and “requested circuit/channel not available”.

Internet Use

In FIG. 5, the collection of Internet Use events and context parameters is represented by the messages exchanged (532) between the operating system communications module (511) and the logging software's Internet Use object (522).

In a preferred embodiment, the Activity object Internet Use (522) collects event and context parameter regarding a user's (or an application's) use of the Internet. This is a hybrid object that in specific implementations may segment more readily into a communication object or an application object depending on the objectives of the market research system.

In a preferred embodiment, the activation of a packet data context initiates the Internet object. In another possible embodiment, the operating system's initiation and use of a specific protocol (e.g. WAP, HTTP, TCP/IP) starts the Internet object. In still another embodiment, an application event, such as browser start, initiates the Internet Use object (522).

The Internet Use object's primary objective is to collect the series of internet addresses accessed during the Internet activity. This parameter may be obtained through a periodic query, or, preferably, upon a notification event received from the operating system when the address changes. Alternatively, the Internet Use object intercepts and filters all communications in an active search for the protocol headers indicating a change in address.

The Internet Use object may collect other contextual parameters during the Internet activity. Such parameters may include, the sent and received byte counts, signal strength, battery levels, and location.

Applications

In FIG. 5, the collection of Application activity events and context parameters is represented by the messages exchanged (533) between the operating system Applications and windows control module (513) and the logging software's Applications object (523). In a preferred embodiment, the activity object Applications targets application-related events and contextual parameters to collect data indicating what applications the panelist is using and the context of this usage.

The Applications object uses three activity-specific events: application start, application focus, and application termination. Application start and termination are similar to communication-start and communication-terminate events and are self-explanatory. An Application focus event indicates when an application controls the primary display window as a result of active use of the application by the user. Other applications may continue to run in the background, but the application focus event which application “owns” the top application window.

The Applications object also collects context parameters such as signal level, battery level, battery status, and location. This list is expanded or reduced depending on the objectives of the specific market research program.

In some embodiments, receipt of an Application start event from a specific, pre-defined application initiates an “input logging” sub-process. Input logging differs from “key logging” processes used in personal computer systems. On a mobile device with a limited numeric key input pad, a user must sometimes press a key multiple times in order to arrive at the desired character. Preferably, the process of the present invention retrieves the character intended as the input, rather than the key presses. In addition, input logging engages only upon receipt of a pre-determined, pre-specified application event. In a mobile environment, such specificity is desirable because untargeted input or key logging quickly results in very large logs, overwhelming scarce memory and incurring high transport costs.

Location

The preferred embodiment also includes a Location object to collect positioning and motion data (524). Preferably, this object retrieves or requests (534) location data (514) through a set of pre-defined APIs provided by the operating system. Alternatively, if such APIs are not available, the Location object communicates with the location system through a serial interface using system-specific APIs.

For basic location information, the present invention uses the network-based positioning information provided as part of the device's cellular communication system. This system reports position as the network, area, and cell identification codes of the current and surrounding cells where the user is located. Once this position information is transported and stored in the database, these codes may be cross-referenced with the known geographical position of the cell base station to provide an estimate of the user's position in a standard format.

In a preferred embodiment in a device with the appropriate systems, the present invention also acquires more precise positioning data in a standardized format such as WGS 84. GPS systems are the best known examples, though other possibilities include network systems specifically designed to offer more precise, standardized geographical references for emergency or commercial purposes. These location systems are either integrated into the mobile device, or operated as external units connected to the mobile device via a short-range wireless connection or a cable. Both systems are contemplated as a source of positioning information in the present invention.

Advantageously, the Location object collects both activity and contextual parameters. As an independent event, positioning data is typically collected using a broad granularity while as a contextual parameter a finer granularity is often used. This method of adapting location granularity is a clear advantage in the mobile environment because it conserves processing power, memory, and bandwidth while also delivering fine precision when required.

A user's motion is an activity, though not one that makes direct use of the mobile device. Nevertheless, the present invention captures this because of its immense value for mobile market and general consumer research. In the field of mobile communications, it is often just as advantageous to understand where consumers are not using the device as well as the specific locations where they are actively using the device for communications or applications.

Positioning data is also a critical contextual parameter, as has been indicated in the preceding discussion of the Communications and Applications objects. Some embodiments require a periodic querying of the location system to capture changes in position. The preferred embodiment uses event-driven positioning, a capability supported by most location systems. In these systems, an event is generated when a user's position or motion relative to some pre-defined point or distance exceeds a threshold. For example, in a cellular network, a cell handover triggers a location event when the user has moved outside the coverage of the previous cell and into a new cell. Using a GPS system, a location event may occur when the user exceeds a distance from a pre-defined point, or comes within a specified range of a pre-defined point, or moves a pre-defined distance from a previously recorded position.

Another advantage of the present invention that it is capable of collecting a network position and a precise geographical position in the context of a specific user activity. One contemplated use records the cell identification, the precise GPS position, and the signal strength and bit error rate of the serving and neighboring cells during an ongoing cellular communication. This provides a means of determining, with precision, the quality of communications service at specific geographical locations. The further advantage is that this radio engineering related data is collected from points where real subscribers actually use cellular communications. With this information, network engineers rate coverage dead spots by the radio characteristics and the potential value of improving service in that region, as indicated by both the communications patterns of subscribers calling from the area, and the communications preferences and spending habits of subscribers who pass through the area but do not attempt calls.

Device

The preferred embodiment includes a Device object that collects device-related performance and status data, such as battery levels, battery re-charge status, signal strength, peripheral device use, and short-range wireless use (525). In this description of a preferred embodiment, the Device object also includes the capability to obtain the “network time”, a parameter indicating the correct time as used by the network. This object retrieves or requests messages (535) through a set of pre-defined APIs provided by the operating system (515).

The Device object operates as both a monitor of activities and a collector of contextual parameters for other objects and activities.

The Device object serves as a direct measure of user activities, including use of: the battery re-charger, peripherals, infra-red, Bluetooth, WiFi, and other hardware available to the user.

The primary role of the Device object is to serve as a means of collecting contextual parameters commonly required by other objects. Once obtained, the value for the target contextual parameter is either returned to the requesting object, logged, or both.

Signal measurement is a critical contextual parameter that is measured using several different methods depending on the requirements of the mobile research program. In some instances, the signal indicator from the device display is collected to provide a simple view of how the consumer perceives the current signal quality. As those skilled in the art will recognize, mobile devices also collect more sophisticated data on signal quality in order to conduct cellular communications. These measures include received metrics such as signal level and bit error rates, and cover the serving cell as well as surrounding cells. Advantageously, the present invention also collects this more sophisticated signal quality data as a contextual parameter when required.

In a preferred embodiment, the Device object also periodically queries the operating system or the communications protocol stack for the “network time” (the current time, as supplied by the cellular communications network). The network time is entered into the log with a time stamp derived from the local operating system. Once transported and stored in the database, these network time entries provide a common reference time (or “index”) for all devices operating in the same network. In most instances, the times used by network operators will be very closely matched, and most likely derived from a single reference source. If not, there are methods well known in the art for comparing the different time stamps of network operators against a common reference point in order to calculate the correct offset.

User Status

The preferred embodiment also includes a User Status object (526) designed to collect data indicating the user's self-defined “profile” status such as ringtone selection, ring volume, ringer state, vibration mode, and the name of the pre-defined profile, if established by the user. This object retrieves or requests messages (536) through a set of pre-defined APIs provided by the operating system (516).

In most embodiments, it is advantageous for the User Status object to operate as an independent activity object. In some circumstances, the User Status object provides contextual parameters to other objects, but only if the User Status object is not already operating to collect user status activity events.

It will be understood by those of ordinary skill in the art that this mobile device usage data collection system, including the logging software and its activity objects, according to the invention, may be altered in various ways within the basic concept of the invention.

1. A monitoring system for a mobile wireless communications device, comprising:
a plurality of local device monitoring systems installed in user mobile communications devices, each local monitoring system including a log of events stored in an associated user device;
wherein said log of events identifies operating and communication system processes executed as a result of user activity; and wherein said log includes the time of the event and the location of the device, as indicated by positioning information obtained from a wireless network or positioning system; wherein said local device monitoring systems send said logs periodically via a wireless communications medium to: a central processing station which receives and stores said log of events from said plurality of mobile device monitors; and a database management system for accessing, processing and generating reports based on said logs.

2. The monitoring system of claim, wherein said logs of user activity include wireless voice, messaging and data communications conducted via local, cellular, or satellite wireless communications systems and networks.

3. The monitoring system of claim, wherein said logging operation includes recording wireless signal quality and battery information parameters at the time of the user activity.

4. The monitoring system of claim, wherein said each device monitor on said associated user device identifies and logs the type and name of media files accessed by the communications and operating systems as a result of user activity.

5. The monitoring system of claim 4, wherein said accessed media files are delivered to the device through a wireless communications system from a remote server.

6. The monitoring system of claim, wherein said each device monitor on said associated user device identifies and includes in the logs media content input by the user.

7. The monitoring system of claim 6, wherein said media content input by the user includes character strings representing an online resource address.

8. The monitoring system of claim, wherein said each device monitor compresses said log and stores said compressed log in said associated user mobile phone.

9. The monitoring system of claim, wherein said each device monitor encrypts said log and wherein said central processing station receives said encrypted log from said plurality of mobile phone monitors.

10. The monitoring system of claim, wherein said each device monitor is installed by users to said associated device through a wireless communication medium.

11. A monitoring method for a mobile wireless communications device comprising the steps of: logging events via a plurality of local device use monitors installed in mobile communications devices, wherein said log of events identifies and records operating system processes indicating user activity, including motion; recording the time of the event; recording the location of the device, as determined by positioning information received by the device from a wireless communications network or a dedicated global positioning system; storing said log of predetermined events by each use monitor in an associated user mobile device; sending said logs from each said associated user mobile device via a wireless communications medium to a central processing facility; receiving and storing said log of predetermined events by a central processing station from said plurality of device monitors; and accessing, processing and generating reports based on the stored predetermined events by a database management system.

12. The monitoring method of claim, wherein the step of logging logs communications activities conducted through a wireless communications network by said each associated user device.

13. The monitoring method of claim, wherein the step of logging further logs device status parameters at the time of the event, including signal quality and battery power levels.

14. The monitoring method of claim, wherein the step of logging further logs the name and type of the media files accessed by the communications and operating systems as a result of user activity.

15. The monitoring method of claim, wherein the step of logging further logs the network address of media files delivered to the device from a remote server via a wireless communications system.

16. The monitoring method of claim, wherein the step of logging further identifies and logs media content input by the user.

17. The monitoring method of claim 16, wherein said media content includes character strings representing an online resource address.

18. The monitoring method of claim 11, wherein the step of logging includes the step of compressing said log and storing said compressed log in said associated user mobile phone.

19. The monitoring method of claim 11, wherein the step of logging includes the step of encrypting said log.

20. The monitoring method of claim 11, further including the step of installing said device monitor on said associated device by downloading said device monitor via a wireless communication medium.
